(19) United States
(12) Patent Application Publication
(10) Pub. No.: US 2009/0107529 A1
(43) Pub. Date: Apr. 30, 2009

(54) DELIVERY OF FLUID TO MEDICAL DEVICE LUMENS

(76) Inventors: Szu-Min Lin, Irvine, CA (US); Robert C. Platt, Laguna Niguel, CA (US); Peter C. Zhu, Cupertino, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/930,245

(22) Filed: Oct. 31, 2007

(51) Int. Cl. B08B 9/027; B08B 13/00

(52) U.S. Cl. 134/22.13; 134/166 C; 134/22.11; 134/22.14

(57) ABSTRACT

A method and device provide for delivering fluid for cleaning and/or decontamination to a lumen in a medical device. A tube having a plurality of openings therethrough is inserted into the lumen of the medical device the fluid is flowed through the tube, out of the openings and into the lumen.

### BACKGROUND OF THE INVENTION

The present invention is directed to providing cleaning and disinfection/sterilization fluid to devices having lumens. It is common to submerse a device in a bucket of high level disinfectant to disinfect the device or a sterilant to sterilize the device. This works less well for devices having lumens due to the difficulty of the liquid entering the lumen. With cleaning the issue is more pronounced as to clean the interior of a lumen it is necessary to flow a cleaning fluid therethrough. There are systems for forcing fluid through a lumen by injecting it into one end and flowing it out the other. Nevertheless, these systems still suffer certain weaknesses. For instance, if the lumen is blocked or occluded fluid will not flow well therethrough. When the lumen is open only at one end, it becomes even more difficult to get fluid therein. The present invention provides a method for ensuring that cleaning or disinfecting/sterilizing fluid will reach internal areas of the lumen. Rather than merely flowing the fluid from one end to the other of a lumen, a tube with a plurality of openings therein, a leaky tube, is inserted into the lumen and fluid is flowed into the lumen through these openings. The invention will now be described in detail of a specific embodiment.

### SUMMARY OF THE INVENTION

A method, according to the present invention, provides for delivering fluid for cleaning and/or decontamination to a lumen in a medical device. The method comprises the steps of: inserting a tube having a plurality of openings therethrough into the lumen of the medical device; and flowing the fluid through the tube, out of the openings and into the lumen.

In one aspect of the invention, the fluid comprises a disinfectant, such as for instance orthophthalaldehyde. In another aspect of the invention the fluid comprises a sterilant.

One useful fluid comprises hydrogen peroxide.

In one aspect of the invention, the fluid comprises a cleaning agent. Cleaning agents can include surfactants, lipid dissolvers enzymatic agents and other cleaning agents useful in removing contaminating material from the medical device. After flowing the cleaning agent through the lumen preferably a disinfectant or a sterilant is flowed through the lumen. Rinsing with a solvent such as water can occur after the cleaning agent and also after the sterilant or disinfectant with the solvent in this rinse preferably being sterile.

Preferably, the tube has an external diameter which is less than 75% of an internal diameter of the lumen. In one aspect of the invention, the tube has an external diameter which is less than 50% of an internal diameter of the lumen.

Preferably, the method further includes the step of flowing the fluid over exterior surfaces of the medical device. The medical device can be an endoscope.

An apparatus, according to the present invention, provides for delivering fluid for cleaning and/or decontamination to a lumen in a medical device. The apparatus comprises an enclosure for containing the medical device, a manifold for distributing fluid to the medical device, and at least one tube in the enclosure connected to the manifold and sized to fit within the lumen of the medical device. The tube has a plurality of openings therethrough into the lumen of the medical device.

A port can be provided for delivering the fluid to the manifold, preferably with an easy connection to a source of the fluid. It can include a self closing or manual valve.

In one aspect of the invention, the at least one tube and the manifold are detachable from the enclosure.

Preferably, a source of the fluid connects to the manifold, the fluid comprising a cleaning agent, rinsing agent, disinfectant, or sterilant. The fluid can be a liquid, mist or gas.

### BRIEF DESCRIPTION OF THE DRAWINGS

FIG. 1 is a top plan view of a tray and fluid delivering tubes according to the present invention;

FIG. 2 is a top plan view of the tray and fluid delivering tubes of FIG. 1, showing the fluid delivering tubes partially removed from the tray; and

FIG. 3 is a top plan view of an alternative tray and fluid delivering tubes according to the present invention.

### DETAILED DESCRIPTION OF THE INVENTION

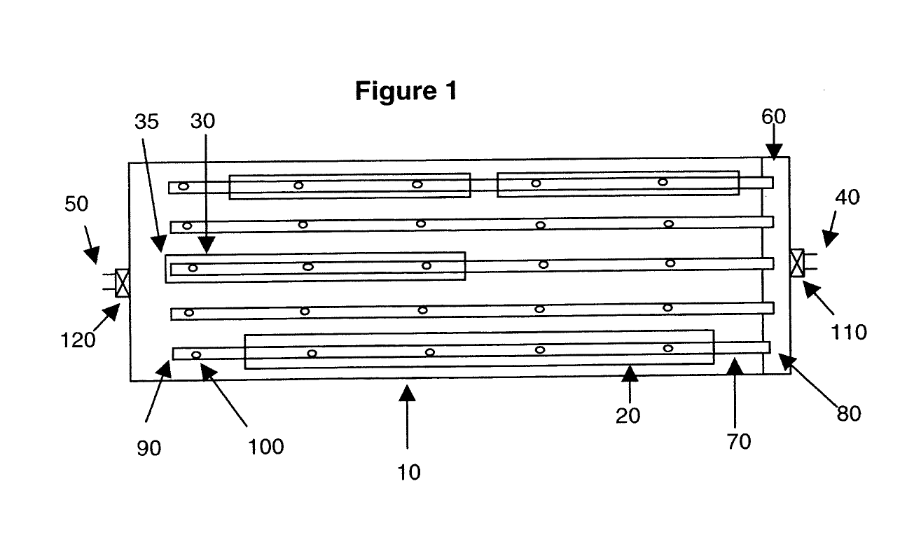

FIG. 1 shows a tray or lidded container 10 for cleaning and/or disinfection/sterilizing a medical device 20 having at least one channel. The medical device may be an instrument 30 having a closed end lumen 35, or alternatively have a lumen open on both ends. The tray 10 has a first fluid port 40, an optional second fluid port 50, a manifold 60 and at least one tube 70 with a first end 80 of each tube connected to the manifold 60 and a second end 90 of the tube in the tray 10, which may be open or closed. Each tube has multiple openings 100 for fluid to flow out. The first fluid port 40 may have a first valve 110. The second fluid port 50 may have a second fluid valve 120. The tubes 70 may have different lengths and diameters. The openings 100 may have different sizes and shapes. During use, fluid flows from the fluid port 40 through the manifold 60 and into tubes 70. The fluid then flows into the tray 10 and/or interior of medical devices 20 and/or 30 through the openings 100 on the tubes 70.

Preferably, the tubes 70 are made of polyamide material, such as those manufactured by Microlumen, Inc. of Tampa, Fla. (http://www.microlumen.com). The polyamide tubes 70 may be coated with fluoropolymer coatings for enhanced chemical resistance and slickness. The openings 100 are formed by laser drilling, which is a flexible method to create openings with various dimensions and shapes. Gateway Laser Services of Maryland Heights, Mo. (http://www.gatewaylaser.com/drilling.html) provides such service.

This simple arrangement allows a procedure for cleaning and high level disinfection or even sterilization of the instrument 30 and especially its lumen 35. Spray nozzles are not shown, but can enhance cleaning of exterior surfaces of the instrument 30, and perhaps, given a particular cycle, provide an equivalent or superior cleaning with less fluid.

In a cleaning and disinfection cycle, first the instrument 20 and/or 30 is placed into the tray 10. Preferably, it has first received a hand cleaning of its exterior and interior surfaces, although with sufficient agitation and a potent cleaning fluid it is possible to effect sufficient cleaning without a manual pre-cleaning. In either event, it is at least preferred to have a sufficient rinse to remove large particles of material.

Into each lumen 35 is placed a tube 70 and each of the tubes 70 are attached to the manifold 60. Preferably, the container 10 has a closure and then cleaning fluid is flowed through the container 10, a portion of which flows through the tubes 70 into the lumen or lumens 35 and another portion of which flows over the exterior surfaces of the instrument 30. By placing the tubes 70 directly through the lumen or lumens 35 it ensures that no blockage can completely block flow therethrough and ensures that even with occlusions that fluid reaches the area thereof and areas downstream to more effectively remove such occlusions.

After a sufficient cleaning period, a rinse solution of water is preferably provided. Then, a solution of disinfectant or sterilant is flowed through the container 10 and tubes 70. Preferred disinfecting/sterilizing fluids include hydrogen peroxide solutions, aldehydes, in particular orthophthaldehyde, and similar liquid solutions. After this step a rinse with sterile water, perhaps followed with an alcohol rinse to promote drying is preferably provided. Although a simple box-like container is illustrated, and sufficient for practice of the invention, it can also be performed in more conventionally known endoscope processors such as shown in U.S. Pat. No. 6,986,736, the entire contents of which is incorporated herein by reference. In such case a flexible manifold would be preferred to allow easier insertion of the tubes 70 into the lumens of the instrument, and even more preferred would be dedicated manifolds with tubes 70 for different models of lumened instruments. Such endoscope reprocessors typically employ a series of flexible tubes, which may be connected together, to connect the reprocessor to the various channels of the endoscope. Here, rather than connect to a channel connector, with all the occlusion issues associated therewith, one of the tubes 70 would instead be inserted into the channel. Thus the channel connector would not be occluded by the connection of the flexible tube.

Arranging the openings 100 of the tubes 70 in the lumen devices 20 and/or 30 provides at least the following advantages, including:
Fluid for cleaning, disinfection and/or sterilization can be very effectively delivered into the interior of devices without using an adaptor, which creates occlusion between lumen device and adaptor
One-end closed lumen device can be processed.
It eliminates the need of checking the blockage of channel during a cleaning or sterilization process. By inserting a tube through a lumen, the user can manually detect whether the lumen is blocked.
Openings not in the lumen can enhance the agitation of fluid for cleaning, disinfection and/or sterilization of exterior surfaces.

Although a liquid is primarily contemplated, the fluid can be any liquid, mist, gas or vapor suitable for cleaning, rinsing, disinfection, and sterilization. The operating pressure can be a combination of positive pressure, atmospheric pressure or negative pressure to facilitate the cleaning, rinsing, disinfection and sterilization process. The composition may comprise an enzyme, surfactant, buffer, chelating agent, coloring agent, prion inactivating agent, corrosion inhibitor, stabilizer, transition metal, germicide, disinfectant, high level disinfectant, sterilant, and/or any cleaning or sterilization enhancing chemicals known in the art now or in the future. Ultrasound may be used to enhance cleaning efficiency. A drying cycle with alcohol rinse, heated air, and/or vacuum can be applied after the cleaning, disinfection or sterilization process.

One preferred chemical for cleaning, disinfection and sterilization is hydrogen peroxide, which is a good and efficient cleaning agent, disinfectant and sterilant. Depending on the concentration, the use of hydrogen peroxide for cleaning may not be effective against lipids and fats from biological contaminants on the instrument. Therefore, it is desired to include a lipid/fat solvent in the hydrogen peroxide solution to enhance the cleaning efficiency.

For the purpose of this invention, dislodging lipid/fat from the surfaces of medical devices during the treatment may be sufficient. The complete dissolving of lipid/fat may not be needed. The preferred lipid solvents include glycol ethers and d-limonene. Preferably, the concentration of solvent to dislodge lipid/fat is from about 0.01 to about 10% by weight, more preferably from about 0.1 to about 5%, and most preferably from 1 to about 3%.

Some examples for cleaning, disinfection and/or sterilization with the use of liquid peroxide comprising lipid solvent are provided. The devices may be any instruments including rigid and flexible endoscopes.
(1) Cleaning→rinsing with water→optional drying.
(2) Disinfection/sterilization→rinsing with filtered water→optional drying.
(3) Cleaning→disinfection/sterilization (different peroxide concentration)→rinsing with filtered water→optional drying.
(4) Cleaning/disinfection/sterilization in one step→rinsing with filtered water→optional drying.
(5) Cleaning→rinsing with peroxide without lipid solvent→removing excess of peroxide→drying/vaporizing/sterilizing with vacuum

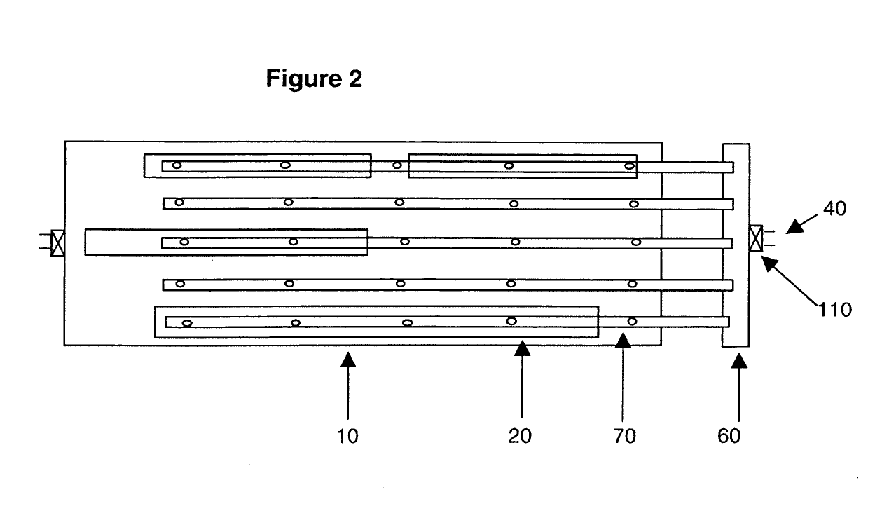

FIG. 2 illustrates that the fluid port 40, optional valve 110 manifold 60, and tubes 70 can be removed from the side of the tray 10 before retrieving devices 20 for use.

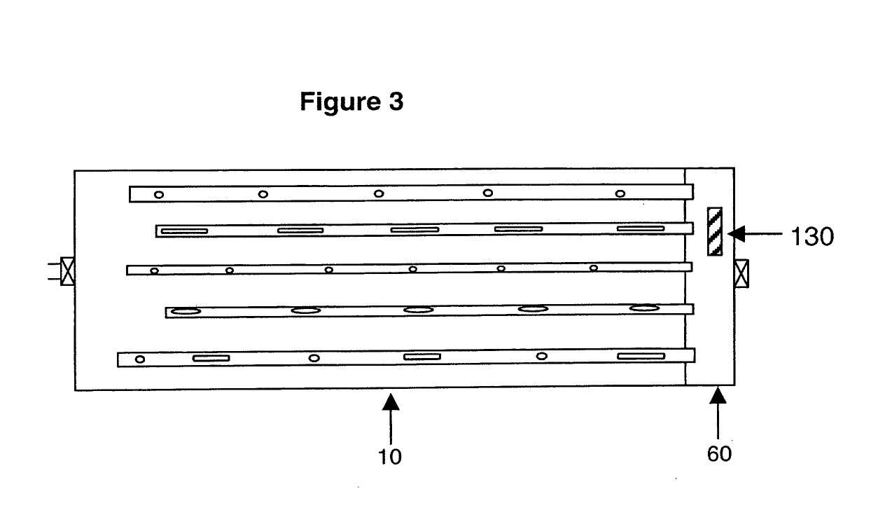

FIG. 3 is a self-contained tray 10 with a source of sterilant 130 in the manifold 60. The source of sterilant 130 may comprise hydrogen peroxide. The hydrogen peroxide may be generated from solid peroxide complex or liquid. The source of peroxide may be packaged in a gas permeable package. The tray 10, manifold 60, and source of peroxide 130 may be heated in an oven or chamber at atmospheric or reduced pressure to facilitate the release of peroxide. The tray may have optional heater (not shown) and insolating material (not shown). The source of sterilant 130 may have a separate heater to provide additional heat. The heat source may be a microwavable heat pack, single use heat pack, or reusable heat pack (http://www.9thtee.com/reheater.htm).

The invention has been described with reference to the preferred embodiments. It is intended that the invention be construed as including all modifications and alterations insofar as they come within the scope of the appended claims or the equivalents thereof.

What is claimed is:

1. A method for delivering fluid for cleaning and/or decontamination to a lumen in a medical device, the method comprising the steps of:
inserting a tube having a plurality of openings therethrough into the lumen of the medical device; and
flowing the fluid through the tube, out of the openings and into the lumen.

2. A method according to claim 1 wherein the fluid comprises a disinfectant.

3. A method according to claim 2 wherein the fluid comprises orthophthalaldehyde.

4. A method according to claim 1 wherein the fluid comprises a sterilant.

5. A method according to claim 1 wherein the fluid comprises hydrogen peroxide.

6. A method according to claim 1 wherein the fluid comprises a cleaning agent.

7. A method according to claim 6 wherein after the step of flowing the cleaning agent through the lumen a disinfectant or a sterilant is flowed through the lumen.

8. A method according to claim 1 wherein the tube has an external diameter which is less than 75% of an internal diameter of the lumen.

9. A method according to claim 8 wherein the tube has an external diameter which is less than 50% of an internal diameter of the lumen.

10. A method according to claim 1 and further comprising the step of flowing the fluid over exterior surfaces of the medical device.

11. A method according to claim 1 wherein the medical device is an endoscope.

12. An apparatus for delivering fluid for cleaning and/or decontamination to a lumen in a medical device, the apparatus comprising:
an enclosure for containing the medical device
a manifold for distributing fluid to the medical device; and
at least one tube in the enclosure connected to the manifold and sized to fit within the lumen of the medical device, wherein the at least one tube has a plurality of openings therethrough into the lumen of the medical device.

13. An apparatus according to claim 12 and further comprising a port for delivering the fluid to the manifold.

14. An apparatus according to claim 12 wherein the at least one tube and the manifold are detachable from the enclosure.

15. An apparatus according to claim 12 and further comprising a source of the fluid connected to the manifold, the fluid comprising a cleaning agent, rinsing agent, disinfectant, or sterilant.

16. An apparatus according to claim 15 wherein the fluid comprises a liquid, mist, or gas.

17. An apparatus according to claim 12 wherein the medical device comprises an endoscope.
